(19) United States
(12) Patent Application Publication
(10) Pub. No.: US 2023/0387425 A1
(43) Pub. Date: Nov. 30, 2023

(54) ELECTROCHEMICAL CELL, GAS RECOVERY SYSTEM EQUIPPED WITH ELECTROCHEMICAL CELL, AND METHOD OF MANUFACTURING ELECTROCHEMICAL CELL

(71) Applicant: DENSO CORPORATION, Kariya-city (JP)

(72) Inventors: Atsuhito OTA, Nisshin-city (JP); Shota KINOSHITA, Nisshin-city (JP); Hironori TATSUMI, Kariya-city (JP); Nobuhiko MATSUDA, Kariya-city (JP)

(21) Appl. No.: 18/308,708

(22) Filed: Apr. 28, 2023

(30) Foreign Application Priority Data
May 31, 2022 (JP) 2022-088380

(51) Int. Cl. H01M 6/02; B01D 53/32; H01M 4/04; H01M 4/62

(52) U.S. Cl. CPC H01M 6/02; B01D 53/326; H01M 4/0416; H01M 4/621; B01D 2313/345

(57) ABSTRACT

An electrochemical cell includes a working electrode and a counter electrode. A voltage is applied between the working electrode and the counter electrode such that electrons are supplied from the counter electrode to the working electrode so as to capture a target species. An electrode film of at least one of the working electrode and the counter electrode has an active material, a conductive aid and a binder. At least a part of the active material is contained as an agglomerate in the electrode film, and the maximum diameter of the aggregate is less than or equal to 10 μm.

### CROSS REFERENCE TO RELATED APPLICATION

This application is based on Japanese Patent Application No. 2022-088380 filed on May 31, 2022, the disclosure of which is incorporated herein by reference.

### TECHNICAL FIELD

The present disclosure relates to an electrochemical cell, a gas recovery system including the electrochemical cell, and a method of manufacturing the electrochemical cell.

### BACKGROUND

A gas recovery system includes an electrochemical cell to adsorb and recover carbon dioxide from a gas containing the carbon dioxide through an electrochemical reaction.

### SUMMARY

An electrochemical cell includes a working electrode and a counter electrode. A voltage is applied between the working electrode and the counter electrode such that electrons are supplied from the counter electrode to the working electrode, so as to capture a target species. An electrode film of at least one of the working electrode and the counter electrode has an active material, a conductive aid and a binder. At least a part of the active material is contained as an agglomerate in the electrode film, and the maximum diameter of the aggregate is less than or equal to 10 μm.

### BRIEF DESCRIPTION OF DRAWINGS

FIG. 1 is a conceptual diagram showing an overall configuration of a carbon dioxide recovery system according to a first embodiment;

FIG. 2 is a perspective view showing a carbon dioxide recovery device in the first embodiment;

FIG. 3 is a perspective view showing electrochemical cells stacked with each other in the first embodiment;

FIG. 4 is a cross-sectional view showing an electrochemical cell in the first embodiment;

FIG. 5 is a partial cross-sectional view of a counter-electrode-side electrode film shown in FIG. 1;

FIG. 6 is an explanatory diagram for explaining a mixed solvent in the first embodiment;

FIG. 7 is a diagram showing a relationship between an active material utilization rate and a modal diameter of a particle of a counter-electrode-side active material;

FIG. 8 is an explanatory diagram for explaining a mixed solvent in a comparative example;

FIG. 9 is an explanatory diagram for explaining a state of a counter-electrode-side active material of an electrode film in a comparative example;

FIG. 10 is an explanatory diagram for explaining a state of a counter-electrode-side active material of the electrode film of the first embodiment; and

FIG. 11 is a diagram showing adsorption property of an electrochemical cell manufactured in the first embodiment and an electrochemical cell manufactured in the comparative example.

### DETAILED DESCRIPTION

A gas recovery system includes an electrochemical cell to adsorb and recover carbon dioxide from a gas containing the carbon dioxide through an electrochemical reaction. An electrode of the electrochemical cell includes an active material and a conductive aid.

In the gas recovery system, the adsorption performance (that is, the electrode performance of the electrochemical cell) may deteriorate due to movement and aggregation of the active material in the electrochemical cell. In response to this, the present inventors have investigated polymerizing the active material in order to suppress the movement of the active material.

However, when the active material is polymerized, the active material tends to aggregate due to the increased intermolecular force. Moreover, when the gas recovery system is used to adsorb and recover carbon dioxide from the atmosphere, the polymerized active material is oxidatively decomposed into low-molecular-weight materials. In addition, electrophoretic migration of the active material during operation of the electrode can degrade the performance of electrode.

The present disclosure provides an electrochemical cell capable of improving performance, a gas recovery system including the electrochemical cell, and a method of manufacturing the electrochemical cell.

An electrochemical cell includes a working electrode and a counter electrode. A voltage is applied between the working electrode and the counter electrode such that electrons are supplied from the counter electrode to the working electrode, so as to capture a target species. An electrode film of at least one of the working electrode and the counter electrode has an active material, a conductive aid and a binder. At least a part of the active material is contained as an agglomerate in the electrode film, and the maximum diameter of the aggregate is less than or equal to 10 μm.

According to this, since the diameter of the aggregate of the active material is small, the area in contact with the conductive path inside the electrode film increases. As a result, the amount of charge supplied from the active material is improved, so that the charge can be easily extracted from the active material. Therefore, it is possible to improve the electrode performance.

A method of manufacturing the electrochemical cell has adjusting a paste of the electrode film for forming the electrode film. The adjusting includes a supporting process of supporting the active material on the conductive aid; and a mixing process of mixing the active material supported by the conductive aid with another constituent material of the electrode film.

According to this, since the active material is previously bound to the conductive aid which has conductivity and is not easily affected by electrophoresis, the active material is restricted from moving and aggregating when the electrochemical cell is operated. As a result, it is possible to suppress an increase in the particle size of the active material, so that the area of the active material in contact with the conductive path can be increased. Therefore, it becomes possible to improve the electrode performance.

Reference numeral indicates an example of correspondence to specific means described in embodiments described later.

Hereinafter, embodiments of the present disclosure will be described with reference to the drawings. In the following embodiments, identical or equivalent elements are denoted by the same reference numerals as each other in the figures.

### First Embodiment

A first embodiment of the present disclosure will be described with reference to the drawings. In this embodiment, as a gas recovery system, a carbon dioxide recovery system 1 separates and recovers carbon dioxide from a mixed gas containing the carbon dioxide. The gas to be recovered (that is, the target species) in this embodiment is carbon dioxide.

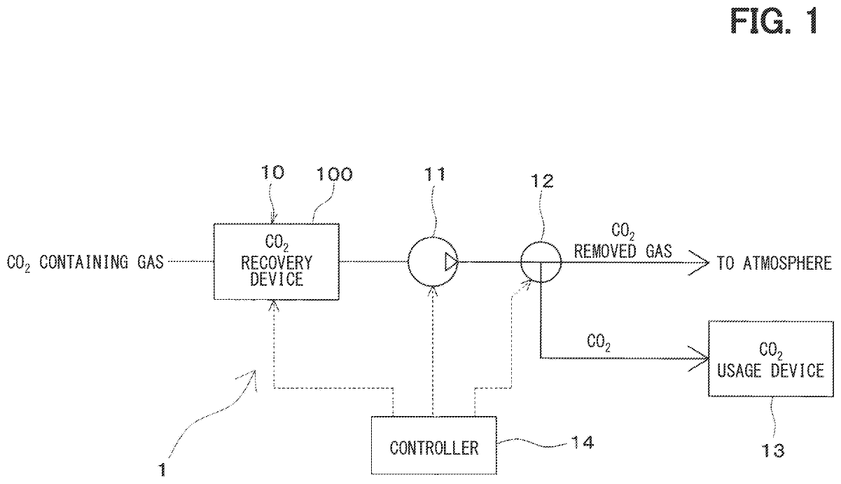

As shown in FIG. 1, the carbon dioxide recovery system 1 of this embodiment includes a carbon dioxide recovery device 10, a pump 11, a channel switching valve 12, a carbon dioxide usage device 13, and a controller 14.

The carbon dioxide recovery device 10 separates and recovers carbon dioxide from a supply gas. The carbon dioxide recovery device 10 has an adsorption section 100 that adsorbs and desorbs carbon dioxide.

The supply gas contains carbon dioxide. The supply gas also contains gases other than carbon dioxide. The supply gas can be, for example, air, exhaust gas from an internal combustion engine, or exhaust gas from a factory. In this embodiment, air is used as the supply gas.

The carbon dioxide recovery device 10 is supplied with supply gas and discharges exhaust gas after carbon dioxide is recovered from the supply gas (hereinafter also referred to as carbon dioxide removed gas) or carbon dioxide recovered from the supply gas. The configurations of the carbon dioxide recovery device 10 and the adsorption section 100 will be described later in detail.

The pump 11 supplies supply gas to the carbon dioxide recovery device 10 and exhausts the carbon dioxide or the exhaust gas from the carbon dioxide recovery device 10. In FIG. 1, the pump 11 is provided downstream of the carbon dioxide recovery device 10 in the gas flow direction, but the pump 11 may be provided upstream of the carbon dioxide recovery device 10 in the gas flow direction.

The channel switching valve 12 is a three-way valve that switches the channel for gas discharged from the carbon dioxide recovery device 10. When the exhaust gas (that is, the carbon dioxide removed gas) is discharged from the carbon dioxide recovery device 10, the channel switching valve 12 switches the channel of the exhaust gas to the atmosphere side, so that the carbon dioxide is released from the carbon dioxide recovery device 10. When the carbon dioxide is discharged from the carbon dioxide recovery device 10, the channel for gas is switched to the carbon dioxide usage device 13.

The carbon dioxide usage device 13 utilizes carbon dioxide. The carbon dioxide usage device 13 is, for example, a storage tank that stores carbon dioxide or a conversion device that converts carbon dioxide into fuel. The conversion device converts carbon dioxide into a hydrocarbon fuel such as methane. The hydrocarbon fuel may be gaseous fuel at normal temperature and pressure, or may be liquid fuel at normal temperature and pressure.

The controller 14 is configured of a well-known microcomputer including a CPU, a ROM, a RAM, and peripheral circuits thereof. The controller 14 performs various calculations and processes based on control programs stored in the ROM, and controls actuations of various devices connected to the output side. The controller 14 of the present embodiment controls operation of the carbon dioxide recovery device operation of the pump 11, the channel switching valve 12, and the like.

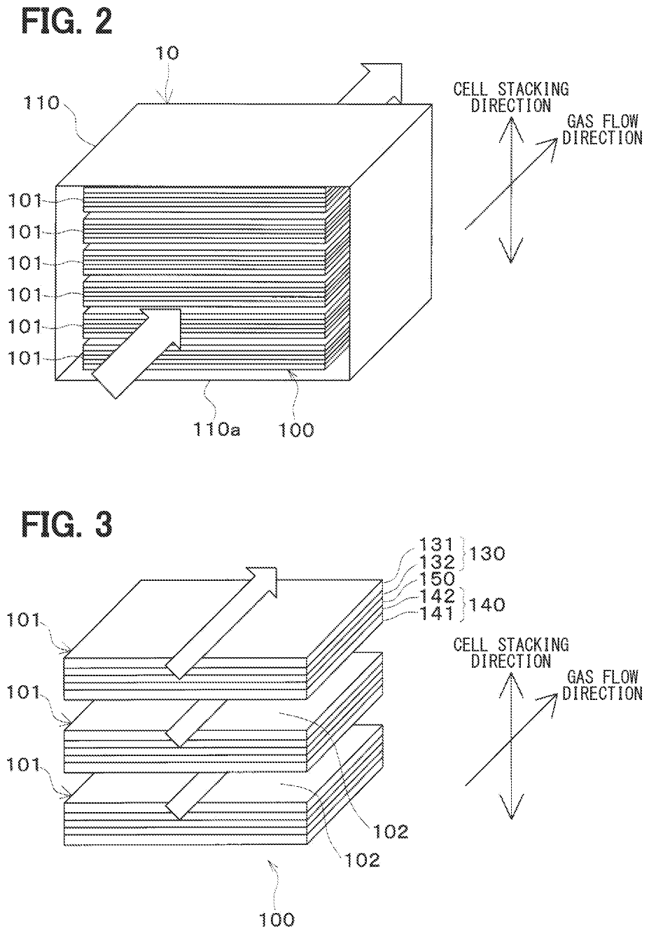

Next, the carbon dioxide recovery device 10 of this embodiment will be described with reference to FIGS. 2 to 4 in which the up-down direction is a cell stacking direction.

As shown in FIG. 2, the carbon dioxide recovery device 10 includes the adsorption section 100 and a housing 110. The housing 110 is formed in a box shape, and made of, for example, a metal material.

The adsorption section 100 has electrochemical cells 101. The electrochemical cell 101 is housed in the housing 110. The carbon dioxide recovery device 10 adsorbs and desorbs carbon dioxide through an electrochemical reaction in the electrochemical cell 101, and separates and recovers the carbon dioxide from the supply gas.

The housing 110 has two openings, one of which is an introduction part 110a for introducing the supply gas inward. The other is an exhaust part (not shown) for discharging the exhaust gas and carbon dioxide from the inside. The gas flow direction is defined when the supply gas passes through the housing 110, from the introduction part 110a of the housing 110 toward the exhaust part.

In FIG. 2, the supply gas flows from the front side of the paper toward the back of the paper. In other words, the housing 110 has the introduction part 110a on the front side in FIG. 2 and the exhaust part on the back side. An open/close member (not shown) for opening and closing each of the introduction part 110a and the exhaust part of the housing 110 is provided.

The electrochemical cells 101 are stacked and arranged inside the housing 110. The cell stacking direction in which the electrochemical cells 101 are stacked is orthogonal to the gas flow direction. Each electrochemical cell 101 is formed in a plate shape and arranged so that the plate surface intersects with the cell stacking direction.

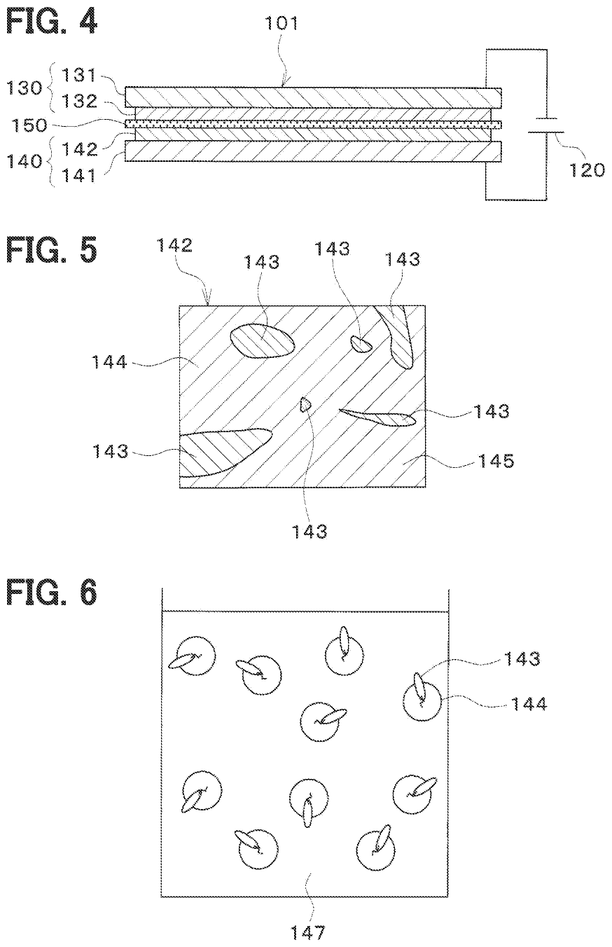

FIG. 3 shows a state in which the electrochemical cells 101 are stacked. FIG. 4 shows one electrochemical cell 101. The constituent elements of the electrochemical cell 101 such as working-electrode-side current collector 131 are stacked and arranged so as to be in contact with each other.

As shown in FIG. 3, a predetermined gap is provided between the electrochemical cells 101 adjacent to each other. The gap provided between the electrochemical cells 101 constitutes a gas channel 102 through which the supply gas flows.

As shown in FIGS. 3 and 4, the electrochemical cell 101 has a working electrode 130, a counter electrode 140 and a separator 150. In the electrochemical cell 101, a voltage is applied between the working electrode 130 and the counter electrode 140, whereby electrons are supplied from the counter electrode 140 to the working electrode 130. When the working electrode 130 is supplied with the electrons, the carbon dioxide that is a target species is captured. The electrochemical cells 101 stacked with each other constitutes an electric field cell stack.

The working electrode 130 has a working-electrode-side current collector 131 and a working-electrode-side electrode film 132. The working-electrode-side current collector 131 is connected to the control power source 120 and is a porous conductive member that allows air to pass through.

As the working-electrode-side current collector 131, for example, a carbonaceous material or a metal material can be used. Carbon paper, carbon cloth, non-woven carbon mat, porous gas diffusion layer (GDL), etc. can be used as the carbonaceous material constituting the working-electrode-side current collector 131. As the metal material forming the working-electrode-side current collector 131, for example, a mesh structure made of metal such as Al, Ni, or SUS can be used.

The working-electrode-side electrode film 132 is a working electrode that adsorbs and desorbs carbon dioxide from the air containing carbon dioxide through an electrochemical reaction. The working-electrode-side electrode film 132 includes a carbon dioxide adsorbent, a working-electrode-side conductive aid, and a working-electrode-side binder.

The carbon dioxide adsorbent is an electroactive species that adsorbs carbon dioxide by receiving electrons and desorbs the adsorbed carbon dioxide by releasing electrons. Examples of carbon dioxide adsorbents are carbon materials, metal oxides, and polyanthraquinone.

The working-electrode-side conductive aid is a conductive substance that forms a conductive path to the carbon dioxide adsorbent. Carbon materials such as carbon nanotubes, carbon black, or graphene can be used as the working-electrode-side conductive aid.

The carbon dioxide adsorbent and the working-electrode-side conductive aid are mixed. For example, the working-electrode-side conductive aid is dissolved in an organic solvent such as NMP (N-methylpyrrolidone), such that the working-electrode-side conductive aid dispersing in the organic solvent is in contact with the carbon dioxide adsorbent.

The working-electrode-side binder is a holding material having adhesive strength. The working-electrode-side binder holds the carbon dioxide adsorbent and the working-electrode-side conductive aid to the working-electrode-side current collector 131. Thereby, the transfer of electrons among the working-electrode-side current collector 131, the carbon dioxide adsorbent, and the working-electrode-side conductive aid can be ensured. In addition, the carbon dioxide adsorbent is less likely to separate from the working-electrode-side current collector 131, and a decrease in the CO₂ adsorption amount of the electrochemical cell 101 over time can be suppressed.

A non-fluid substance having no fluidity can be used as the working-electrode-side binder. Examples of non-fluid substances include gel substances and solid substances. An ionic liquid gel can be used as the gel substance. As the solid substance, for example, a solid electrolyte, a conductive resin, or the like can be used.

When a solid electrolyte is used as the working-electrode-side binder, it is desirable to use an ionomer made of a polymer electrolyte or the like in order to increase the contact area with the carbon dioxide adsorbent. When a conductive resin is used as the working-electrode-side binder, an epoxy resin containing Ag or the like as the conductive filler, or a fluororesin such as polytetrafluoroethylene (PTFE), polyvinylidene fluoride (PVDF) can be used.

Then, a mixture of the carbon dioxide adsorbent, the working-electrode-side conductive aid, and the working-electrode-side binder is formed, and this mixture is adhered to the working-electrode-side current collector 131. The carbon dioxide adsorbent and the working-electrode-side conductive aid are held inside the working-electrode-side binder. Therefore, the carbon dioxide adsorbent and the working-electrode-side conductive aid can be firmly held by the working-electrode-side binder. In addition, the carbon dioxide adsorbent and the working-electrode-side conductive aid are less likely to separate from the working-electrode-side current collector 131.

The counter electrode 140 has a counter-electrode-side current collector 141 and a counter-electrode-side electrode film 142. The counter-electrode-side current collector 141 is a conductive member connected to the control power source 120. The counter-electrode-side current collector 141 may be made of the same material as the working-electrode-side current collector 131, or may be made of a different material.

The counter-electrode-side electrode film 142 exchanges electrons with the working-electrode-side electrode film 132. As shown in FIG. 5, the counter-electrode-side electrode film 142 has a counter-electrode-side active material 143, a counter-electrode-side conductive aid 144 and a counter-electrode-side binder 145.

The counter-electrode-side active material 143 is an auxiliary electroactive species that gives and receives electrons to and from the carbon dioxide adsorbent. The counter-electrode-side active material 143 can take in and out electrons by changing the valence of the metal and by moving charges into and out of the π-electron cloud. At least a part of the counter-electrode-side active material 143 is contained as agglomerate in the counter-electrode-side electrode film 142.

As the counter-electrode-side active material 143, for example, a metal complex that allows electron transfer by changing the valence of metal ions can be used. Examples of the metal complex include cyclopentadienyl metal complexes such as ferrocene, nickelocene and cobaltocene, and porphyrin metal complexes.

In this embodiment, a compound having a ferrocene skeleton is used as the counter-electrode-side active material 143. Specifically, polyvinylferrocene (PVFc) in which ferrocene is polymerized is used as the counter-electrode-side active material 143.

The counter-electrode-side conductive aid 144 is a conductive material that forms a conductive path to the counter-electrode-side active material 143. The counter-electrode-side conductive aid 144 is used by being mixed with the counter-electrode-side active material 143. The counter-electrode-side conductive aid 144 may be made of the same material as the working-electrode-side conductive aid, or may be made of a different material. The counter-electrode-side conductive aid 144 is, for example, particulate.

The counter-electrode-side binder 145 has conductivity and is capable of holding the counter-electrode-side active material 143 and the counter-electrode-side conductive aid 144 to the counter-electrode-side current collector 141. The counter-electrode-side binder 145 may be the same material as the working-electrode-side binder, or may use a different material.

The counter-electrode-side active material 143 is bonded to at least one of the members constituting the counter-electrode-side electrode film 142 (that is, the counter-electrode-side conductive aid 144 and the counter-electrode-side binder 145) by intermolecular force or chemical bonding.

As shown in FIG. 4, the separator 150 is arranged between the working-electrode-side electrode film 132 and the counter-electrode-side electrode film 142. The separator 150 separates the working-electrode-side electrode film 132 and the counter-electrode-side electrode film 142 from each other. That is, the separator 150 prevents physical contact between the working-electrode-side electrode film 132 and the counter-electrode-side electrode film 142. Moreover, the separator 150 suppresses electrical short-circuiting between the working-electrode-side electrode film 132 and the counter-electrode-side electrode film 142.

The separator 150 is made of a cellulose film, a polymer, a composite material of polymer and ceramic. A porous separator may be used as the separator 150.

An ion conductive member may be provided between the working-electrode-side electrode film 132 and the separator 150 or/and between the counter-electrode-side electrode film 142 and the separator 150. The ion conductive member facilitates electrical conduction to the carbon dioxide adsorbent. In this embodiment, an electrolytic solution is provided as the ion conductive member. An ionic liquid can be used as the electrolytic solution. An ionic liquid is a salt of a liquid having non-volatility under normal temperature and pressure.

The control power source 120 is a power supply device for the carbon dioxide recovery system 1. The control power source 120 supplies power to each device of the carbon dioxide recovery system 1. The control power source 120 changes the potential difference between the working electrode 130 and the counter electrode 140 by applying a predetermined voltage to the electrochemical cell 101 according to instructions. The working electrode 130 is a negative electrode, and the counter electrode 140 is a positive electrode.

The electrochemical cell 101 operates an adsorption process in which the working electrode 130 adsorbs carbon dioxide and a desorption process in which carbon dioxide is desorbed from the working electrode 130 by switching such as changing the potential difference between the working electrode 130 and the counter electrode 140. The adsorption process is a charging process for charging the electrochemical cell 101, and the desorption process is a discharging process for discharging the electrochemical cell 101.

In the adsorption process, a first voltage V1 is applied between the working electrode 130 and the counter electrode 140, and electrons are supplied from the counter electrode 140 to the working electrode 130. At the first voltage V1, the counter electrode potential is greater than the working electrode potential. The first voltage V1 may fall within the range between 0.5 and 2.0 V.

In the desorption process, a second voltage V2 is applied between the working electrode 130 and the counter electrode 140, and electrons are supplied from the working electrode 130 to the counter electrode 140. The second voltage V2 is different from the first voltage V1. The second voltage V2 is lower than the first voltage V1, and the magnitude relationship between the working electrode potential and the counter electrode potential is not limited. That is, in the desorption process, the working electrode potential may be smaller than the counter electrode potential, the working electrode potential may be equal to the counter electrode potential, or the working electrode potential may be larger than the counter electrode potential.

Next, a formation process for forming the counter-electrode-side electrode film 142 of the electrochemical cell 101 of this embodiment will be described. The formation process includes a paste adjustment process for adjusting the paste of electrode film for forming the counter-electrode-side electrode film 142.

In the paste adjustment step, first, a supporting step is performed to support the counter-electrode-side active material 143 on the counter-electrode-side conductive aid 144. In the supporting step, the counter-electrode-side active material 143 is bonded to the counter-electrode-side conductive aid 144. In this embodiment, polyvinylferrocene (PVFc) is used as the counter-electrode-side active material 143 and carbon black (CB) is used as the counter-electrode-side conductive aid 144.

In order to chemically bond the counter-electrode-side active material 143 to carbon black, which is the counter-electrode-side conductive aid 144, it is effective to add a functional group on the surface of the carbon black, such that the functional group bonds to the counter-electrode-side active material 143. At this time, examples of the functional group added to the surface of carbon black include a carboxyl group, a hydroxyl group, a quinone group, an aldehyde group, and a carbonyl group. The functional group added to the surface of the carbon black and the counter-electrode-side active material 143 form an ester bond or an amide bond to bind the counter-electrode-side active material 143 to the carbon black.

In order to bond the counter-electrode-side active material 143 to the carbon black which is the counter-electrode-side conductive aid 144 by intermolecular force, it is effective to create active reaction sites such as unpaired electrons and radicals on the surface of the carbon black.

Examples of methods for forming the above-described functional group and active reaction site on the surface of carbon black include acid treatment, high-temperature thermal oxidation, radiation grafting, electron beam grafting, and the like.

Subsequently, a mixing step is performed to mixing the counter-electrode-side active material 143 supported by the counter-electrode-side conductive aid 144 with the counter-electrode-side binder 145 which is another constituent material of the counter-electrode-side electrode film 142. In the mixing step, the counter-electrode-side conductive aid 144 supporting the counter-electrode-side active material 143 is mixed with the organic solvent 147 and the counter-electrode-side binder 145. As a result, as shown in FIG. 6, the counter-electrode-side conductive aid 144 supporting the counter-electrode-side active material 143 is dispersed in the mixed solvent in which the organic solvent 147 and the counter-electrode-side binder 145 are mixed. After that, the mixed solvent is concentrated to prepare the paste of electrode film. In this embodiment, N-methylpyrrolidone (NMP) is used as the organic solvent 147 and polyvinylidene fluoride (PVDF) is used as thee counter-electrode-side binder 145.

After the paste adjustment process, a coating process is performed to apply the paste of electrode film on the counter-electrode-side current collector 141. Also, a drying process for drying the paste of electrode film is performed. Thus, the formation process is finished.

The present inventors examine the active material utilization rate relative to the modal diameter of particle of the counter-electrode-side active material 143 in the recovery of carbon dioxide using the electrochemical cell 101 including the counter-electrode-side electrode film 142 obtained in the above-described formation process. The active material utilization rate is represented by a ratio of the number of electrons entering and exiting the counter-electrode-side active material 143 contained in the counter-electrode-side electrode film 142 to the number of electrons flowing through the electrochemical cell 101.

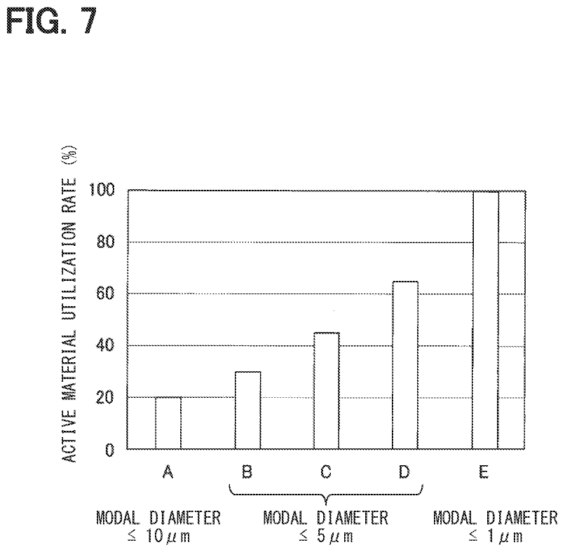

As samples, a sample A having a modal particle size of 10 μm or less, samples B, C, and D having a modal particle size of 5 μm or less, and a sample E having a modal particle size of 1 μm or less were prepared. The results are shown in FIG. 7.

As shown in FIG. 7, the sample A with a modal particle size of 10 μm or less had an active material utilization rate of 20%, which means that the counter-electrode-side active material 143 is effectively utilized.

The samples B, C, and D having a modal particle size of 5 μm or less exhibited higher active material utilization rate than the sample A. Furthermore, in the case of sample E having a modal particle size of 1 μm or less, the active material utilization rate was 100%. Therefore, the smaller the particle diameter of the counter-electrode-side active material 143 in the counter-electrode-side electrode film 142, the better the contact between the particle surface and the conductive path. Since the amount of electrons supplied from the counter-electrode-side active material 143 is increased, the adsorption performance is improved. Therefore, sufficient performance of the electrochemical cell 101 can be obtained by setting the maximum diameter of the aggregates of the counter-electrode-side active material 143 to 10 μm or less, preferably 1 μm or less.

As described above, in the electrochemical cell 101 of the present embodiment, the counter-electrode-side active material 143 is contained in the counter-electrode-side electrode film 142 as plural aggregates aggregated in the counter-electrode-side electrode film 142, and the maximum diameter of the aggregate is 10 μm or less. Accordingly, since the diameter of the aggregate of the counter-electrode-side active material 143 is small, the area in contact with the conductive path inside the counter-electrode-side electrode film 142 increases. As a result, the amount of charge supplied from the counter-electrode-side active material 143 is improved, so that the charge can be easily extracted from the counter-electrode-side active material 143. Therefore, the performance of the counter electrode 140 can be improved.

In the electrochemical cell 101 of the present embodiment, the counter-electrode-side active material 143 is bonded to at least one of the counter-electrode-side conductive aid 144 and the counter-electrode-side binder 145 of the counter-electrode-side electrode film 142 due to molecular force bonding or by chemical bonding. Specifically, in the present embodiment, the counter-electrode-side active material 143 is chemically bonded to carbon, which is the counter-electrode-side conductive aid 144. According to this, the counter-electrode-side active material 143 is dispersed together with the counter-electrode-side conductive aid 144 and the like, so movement and aggregation can be suppressed.

Furthermore, since the counter-electrode-side active material 143 is bound to the counter-electrode-side conductive aid 144 to which electric charges move, the reaction of the counter-electrode-side active material 143 is likely to occur. This makes it possible to reduce the overvoltage.

Further, in the present embodiment, the counter-electrode-side active material 143 is supported in advance on the counter-electrode-side conductive aid 144 when forming the counter-electrode-side electrode film 142. The counter-electrode-side conductive aid 144 has conductivity and is less susceptible to electrophoresis. Therefore, the counter-electrode-side active material 143 bonded to the counter-electrode-side conductive aid 144 is also less susceptible to electrophoresis. As a result, when the electrochemical cell 101 is in operation, it is possible to restrict the counter-electrode-side active material 143 from moving and aggregating due to electrophoresis. As a result, it is possible to suppress an increase in the particle diameter of the counter-electrode-side active material 143, so that the area of the counter-electrode-side active material 143 in contact with the conductive path can be increased. Therefore, it becomes possible to improve the electrode performance.

The inventors compared the effects of the formation process of forming the counter-electrode-side electrode film 142 in this embodiment with a case of forming the counter-electrode-side electrode film 142 by a formation process according to the conventional technique. The process of forming the counter-electrode-side electrode film 142 in the comparative example will be described below.

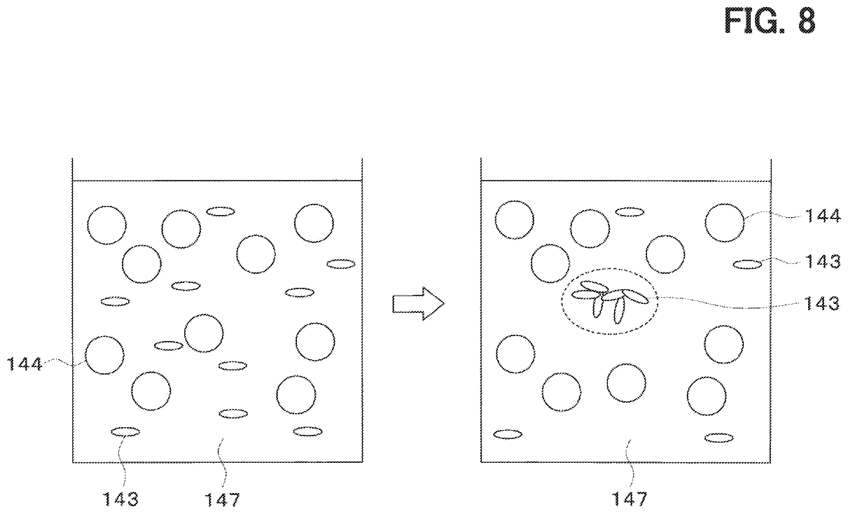

In the comparative example, as shown in FIG. 8, the counter-electrode-side active material 143 is dispersed in a mixed solution of the organic solvent 147 and the counter-electrode-side binder 145, and then the counter-electrode-side conductive aid 144 is mixed to obtain a paste of electrode film. After that, the coating process and the drying process are performed in the same manner as in the present embodiment.

In the comparative example, PVFc is used as the counter-electrode-side active material 143, CB is used as the counter-electrode-side conductive aid 144, NMP is used as the organic solvent 147, and PVDF is used as the counter-electrode-side binder 145, as in the present embodiment.

In the step of forming the counter-electrode-side electrode film 142 in the comparative example, the counter-electrode-side active material 143 is not bound to the counter-electrode-side conductive aid 144, so the counter-electrode-side active material 143 moves and agglomerates. As a result, the particle size of the counter-electrode-side active material 143 increases, and the area of the counter-electrode-side active material 143 that does not contact the conductive path increases. As a result, the electrode performance is lowered, and the carbon dioxide adsorption performance is lowered.

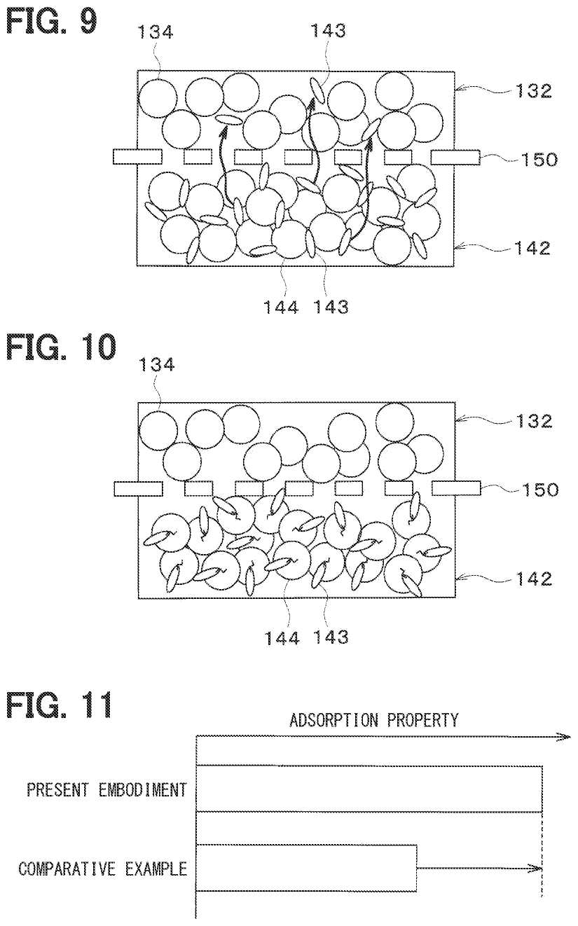

In the electrochemical cell 101 having the counter-electrode-side electrode film 142 formed by the formation process of the comparative example, as shown in FIG. 9, the counter-electrode-side active material 143 flows out of the counter-electrode-side electrode film 142 to the working-electrode-side electrode film 132. In this case, the counter-electrode-side electrode film 142 may deteriorate. When the counter-electrode-side active material 143 moves toward the working electrode 130, electrons are given and received to the counter-electrode-side active material 143 that has moved instead of the carbon dioxide adsorbent, which may reduce the carbon dioxide adsorption capacity.

In contrast, as shown in FIG. 10, in the electrochemical cell 101 having the counter-electrode-side electrode film 142 formed by the formation process of the present embodiment, the counter-electrode-side active material 143 is bonded to the counter-electrode-side conductive aid 144. Since carbon is used for both the counter-electrode-side conductive aid 144 and the working-electrode-side conductive aid 134, it is less susceptible to concentration diffusion. Therefore, the counter-electrode-side conductive aid 144 to which the counter-electrode-side active material 143 is bound is suppressed from moving from the counter-electrode-side electrode film 142 to the working-electrode-side electrode film 132. As a result, deterioration of the counter-electrode-side electrode film 142 due to the flow of the counter-electrode-side active material 143 from the counter-electrode-side electrode film 142 to the working-electrode-side electrode film 132 can be suppressed.

FIG. 11 shows a comparison of the adsorption property of carbon dioxide between the electrochemical cell 101 having the counter-electrode-side electrode film 142 formed by the formation process of the comparative example and the electrochemical cell 101 having the counter-electrode-side electrode film 142 formed by the formation process of the present embodiment. As shown in FIG. 11, the electrochemical cell 101 in which the counter-electrode-side electrode film 142 is formed in the formation process of the present embodiment has 1.5 times the adsorption property relative to the electrochemical cell 101 in which the counter-electrode-side electrode film 142 is formed in the formation process of the comparative example.

### Second Embodiment

Next, a second embodiment of the present disclosure will be described. The second embodiment differs from the first embodiment in the supporting step in the paste adjustment step of the formation process to form the counter-electrode-side electrode film 142 of the electrochemical cell 101.

In the supporting step of the present embodiment, the counter-electrode-side active material 143 is bonded to carbon black as the counter-electrode-side conductive aid 144 via a silane coupling agent.

According to the studies by the present inventors, it is difficult for the counter-electrode-side active material 143 to form a bond with other components such as the counter-electrode-side conductive aid 144, which may result in a poor yield. However, when a silane coupling agent is used as in the present embodiment, it becomes possible to add a more reactive functional group to the surface of the bonding portion, and the yield can be improved. Moreover, by using a highly reactive functional group, the bonding conditions become easier, and a less expensive substance can be used as the counter-electrode-side active material 143. As a result, the manufacturing cost of the electrochemical cell 101 can be reduced.

### Other Embodiment

The present disclosure is not limited to the embodiments described above, and various modifications can be made as follows within a range not departing from the spirit of the present disclosure. The means disclosed in the individual embodiments may be appropriately combined within a feasible range.

In the embodiment, the counter-electrode-side electrode film 142 contains at least part of the counter-electrode-side active material 143 as aggregate, and the maximum diameter of the aggregate is set to 10 μm or less, but it is not limited to this aspect. For example, the working-electrode-side electrode film may contain at least part of the active material as agglomerate, and the maximum diameter of the agglomerate may be 10 μm or less. As the active material in the working-electrode-side electrode film, for example, a carbon dioxide adsorbent or a catalyst may be used.

In the embodiment, the method for manufacturing an electrochemical cell according to the present disclosure is applied to the formation process forming the counter-electrode-side electrode film 142. Alternatively, the method for manufacturing an electrochemical cell according to the present disclosure can be applied to the formation process forming the working-electrode-side electrode film 132.

What is claimed is:

1. An electrochemical cell comprising:
a working electrode; and
a counter electrode opposing the working electrode, wherein electrons are supplied from the counter electrode to the working electrode by applying a voltage between the working electrode and the counter electrode, so as to capture a target species,
an electrode film constituting at least one of the working electrode and the counter electrode has an active material, a conductive aid and a binder,
at least a part of the active material is contained as an agglomerate in the electrode film, and
the agglomerate has a maximum diameter less than or equal to 10 μm.

2. The electrochemical cell according to claim 1, wherein the active material is bonded to at least one of the conductive aid and the binder of the electrode film by intermolecular force or chemical bonding.

3. The electrochemical cell according to claim 2, wherein the active material is bonded to the conductive aid via a silane coupling agent.

4. A gas recovery system comprising the electrochemical cell according to claim 1.

5. A method of manufacturing the electrochemical cell according to claim 1 comprising:
adjusting a paste of the electrode film to form the electrode film, wherein the adjusting includes:
supporting the active material on the conductive aid; and
mixing the active material supported by the conductive aid with another constituent material of the electrode film.

6. The method according to claim 5, wherein the another constituent material is the binder.
